(19) United States
(12) Patent Application Publication
(10) Pub. No.: US 2010/0097232 A1
(43) Pub. Date: Apr. 22, 2010

(54) Method for determining empty oxygen tank and device therefor

(76) Inventors: Jason Albert Lee, Molino, FL (US); Edward Mathew Cates, Pensacola, FL (US); Marion Edmond Ellis, Pensacola, FL (US)

Correspondence Address: Mr. Marion E. Ellis, 1160 Peperidge Drive, Pensacola, FL, 32504, US

(21) Appl. No.: 12/587,726

(22) Filed: Oct. 13, 2009

Related U.S. Application Data
(60) Provisional application No. 61/196,445, filed on Oct. 17, 2008.

(51) Int. Cl. G08B 21/00

(52) U.S. Cl. 340/626; 340/691.5

(57) ABSTRACT

A cost effective method is provided for determining empty and/or near empty medical and other medical emergency oxygen tanks employing a single, simple device for practicing the method, comprised of 5 or 6 readily obtainable components, to issue visual and audible alarms when the oxygen pressure of a medical oxygen tank has decreased to a predetermined pressure, deemed too low to provide the needed and/or prescribed oxygen flow rate to a patient to alert medical personnel and other caregivers that it is time to replace the tank in with a full tank.

### CROSS-REFERENCE TO RELATED APPLICATION

The application claims the benefit of U.S. Provisional Patent Application Ser. No. 61/196,445 filed Oct. 17, 2008

### FIELD OF THE INVENTION

A method for determining empty and/or near empty medical oxygen tanks and a device for practicing the method are provided. More specifically the method provides for confirming when the oxygen in a medical oxygen tank is depleted to the point that there is insufficient pressure to provide the needed and/or prescribed oxygen flow rate to a patient and further provides a device with a visual alarm and an auditory alarm to alert medical personnel and other caregivers that it is time to replace the tank in use with a full tank.

### BACKGROUND OF THE INVENTION

Often, patients requiring supplemental oxygen following trauma, or during recuperation and/or as a result of breathing problems caused by lung or circulatory problems as well as their caregivers are unaware, in spite of the pressure gauge on each tank's oxygen regulator when the oxygen pressure of their tank has been depleted to the point that there is not sufficient pressure (conventionally considered to be less than 500 psi) to provide the needed or prescribed rate of oxygen flow. Such patients can suffer serious injury or even death if their supplemental oxygen is less than needed or prescribed or stopped or interrupted.

History has shown that the pressure gauge affixed to a medical oxygen tank regulator is not a sufficient safeguard to prevent patients from running out of oxygen. There are many instances where oxygen tanks showing a pressure of 500 psi or less on the pressure gauge are not replaced with full tanks. For various reasons, the pressure gauge goes unseen and the oxygen tank unattended. Numerous deaths, reported worldwide, resulting from patients running out of oxygen and/or being connected to empty or near empty oxygen tanks; then running out of oxygen, can be found in the literature and on the interne. In spite of the lives lost; there is no pervasive solution to the problem in practice and patients are at risk everyday. This does not to say that solutions have not been put forth.

An oxygen gauge having a visual alarm and an audible alarm which sounds when pressure decreases to 500 psi can be purchased from Pegasus Research Corporation, 3303 Harbor Blvd. F3, Costa Mesa, Calif. 92626, for about $150 to $180. Such an alarming oxygen gauge is not in pervasive use and its existence little known by caretakers. Since this is the case; it can be concluded that the decision to employ such an alarming gauge is cost driven and that the medical market will not support an oxygen gauge costing $150 to $180. Typically oxygen regulators, which include a conventional pressure gauge, can be purchased for around $40 to $60. The use of such an alarming gauge in place of the conventional oxygen gauge on a regulator would drive the cost of the oxygen regulator to over $200. In other words the $150 to $180 price tag for an alarming pressure gauge is too costly and decision makers opt to stay with the status quo; the standard oxygen pressure gauge and accept the risk involved. The burden of the risk falls on the caregiver as well as the patient who are subject to human error.

Inventions specifically aimed at alerting medical personnel to a drop in oxygen pressure or oxygen flow failure and mitigate the risk include: U.S. Pat. No. 3,952,740 issued Apr. 27, 1976 to James E. Scurlock; U.S. Pat. No. 6,209,579 B1 issued Apr. 3, 2001 Bowden et al.; U.S. Pat. No. 6,386,196 B1 issued May 14, 2002 to Steven E. Culton; U.S. Patent Application Publication 2008/0150739 A1, Publication Date Jun. 26, 2008, Inventor Stephen C. F. Gamard; and U.S. Patent Application Publication 2008/0251074 A1, Publication Date Oct. 16, 2008, Inventor Robert H. Sand.

Scurlock U.S. Pat. No. 4,598,279 discloses an inventive apparatus to monitor gas flow for an anesthetic machine which will alert the operator in the event of either a fall in oxygen pressure or any other event leading to inadequate oxygen flow while other gases are being supplied. Operation of the inventive device is effected principally by a fluidic OR/NOR gate having a maximum operating pressure of approximately 10 psi (pounds per square inch). With, for example, a 1.0 liter per minute setting for the oxygen flow rate; the alarm will sound if more than 0.8 liter per minute of nitrous oxide and less than 1.0 liter per minute of oxygen are flowing. A pneumatically actuated switching means connected between the NOR output leg of the fluidic gate causes the alarm to be energized and sound.

Bowden et al. discloses an in-line low supply pressure alarm device housed together with a gas pressure regulator. The alarm device is inserted in-line and includes a housing with a gas inlet, a gas outlet and an elongate internal chamber. The alarm, an audible reed and a whistle, is activated when the gas flow output of the pressure regulator ceases or becomes too low.

Culton discloses an oxygen delivery system which provides a visual and an audible warning signal for system or oxygen flow failure. The alarm device is comprised of a clear plastic housing having a fan that turns in response to oxygen flow to visually indicate the oxygen supply is operational and an audible whistle. When there is no oxygen flow the fan ceases to turn and the whistle alarm sounds. Typically oxygen is metered from the source to the patient through plastic tubing. The device is inserted (like a splice marrying two length of plastic tubing) in-line between the oxygen supply source; which can be the low pressure output of an oxygen regulator attached to an oxygen tank, and the patient.

Gamard discloses a gas cylinder (tank) alarm and monitoring device comprising: a portable housing adapted to be removably affixed to a medical gas cylinder; a user interface coupled to the housing and adapted to receive selected user inputs; an output disposed within the housing and adapted to provide an alarm notification; and a processor disposed within the housing and operatively coupled to the user interface and the output. The processor is adapted to ascertain the remaining duration until the medical gas cylinder reaches a prescribed pressure threshold value based on user inputs and provide a signal to the output, comprised of a visual display and an audible alarm, when the remaining duration reaches the alarm threshold. The processor, to ascertain the remaining duration or use time, relies on user inputs of gas cylinder size, gas cylinder pressure, and flow rate. The prescribed threshold value is 500 psig. Unlike the Scurlock, Bowden et al. and Culton patents; the inventive device in no way is in actual communication with the oxygen pressure or flow of the medical cylinder supplying the patient. The visual and audible alarms are activated based solely on a mathematical calculation of use time remaining for a given medical cylinder.

Sand discloses a two device method for remote monitoring of remaining gas supplies in gas cylinders or tanks employed to supply oxygen to patients. A first device employs a pressure sampling component (pressure transducer) to continuously report sequential electronic signals to a second device, a remote receiver carried by a caregiver.

Referring to Sand FIGS. 1-4; the inventive device 10 is comprised of a first device, further comprised of a tank mounted transmission component 14 and a second device, a remote receiver or alert 12.

The tank mounted component 14 is further comprised of a pressure transducer 20 to continuously monitor gas pressure, a microprocessor 22, an RF Transceiver 16, an antenna, an LED or other display 30 and a battery 40 housed together with a conventional analog oxygen pressure gauge.

The remote receiver or alert 12 is further comprised of an RF transceiver 18, a Microprocessor 22, an LED or other display 30, an antenna and a Buzzer or Speaker.

In operation the tank mounted transmission component 14 wirelessly transmits, by low strength radio, to the remote receiver or alert 12. The transmitted electronic signal by means for wireless transmission such as the transmitter 16 operatively communicating with the transducer 20 and microprocessor 22, which is controlled by software adapted to the task of monitoring tank pressure; contains a sampling, taken at chosen time intervals, of tank pressure information.

The tank pressure information received by the remote receiver or alert 12 is enabled with a software routine or algorithm which calculates and predicts tank change intervals or times to a caretaker 15 or other third party responsible for the patient who is wearing the alert as depicted in FIG. 4.

The visual alarm 30 and audible buzzer or speaker alarm on the remote alert 12 inform the caretaker or user 15 wearing the device about calculated replacement times for the oxygen tank being monitored.

None of foregoing solutions or inventions or patents either singly or in combination describes the current invention.

### SUMMARY OF THE INVENTION

It is the primary object of the current invention to provide a cost effective method employing a single, simple device comprised of 5 or 6 readily obtainable components to alert medical personnel and caregivers to the fact that a patient's oxygen tank pressure has been depleted to the point it is deemed empty or has insufficient pressure to provide the prescribed oxygen flow; which, is conventionally held, within the medical industry, to be less than about 500 psi.

It is another object of this invention to provide a visual indication that the oxygen tank's pressure has reached that point.

It is further object of this invention to provide an audible alert that the oxygen tank's pressure has reached that point.

These and other objects of the instant invention will become apparent upon further review of the following specifications and drawings.

### BRIEF DESCRIPTION OF DRAWINGS

The above and other advantages of the current invention will become more apparent from the following description taken in conjunction with the accompanying drawing, in which:

FIG. 1 is an electrical circuit diagram of the basic embodiment of the inventive device for practicing the method of the current invention showing the 5 components comprising the device.

FIG. 2 is an electrical circuit diagram of a second embodiment of the inventive device for practicing the method of the current invention showing the 6 components comprising the device.

FIG. 3 is a diagram illustrating the use of an “oxygen clean” T connector to connect the inventive device to a standard oxygen regulator.

### DETAILED DESCRIPTION OF THE INVENTION

A method and device for practicing the method are provided to sense the presence of or the absence of pressure for a medical oxygen tank of the type used by patients who require additional oxygen.

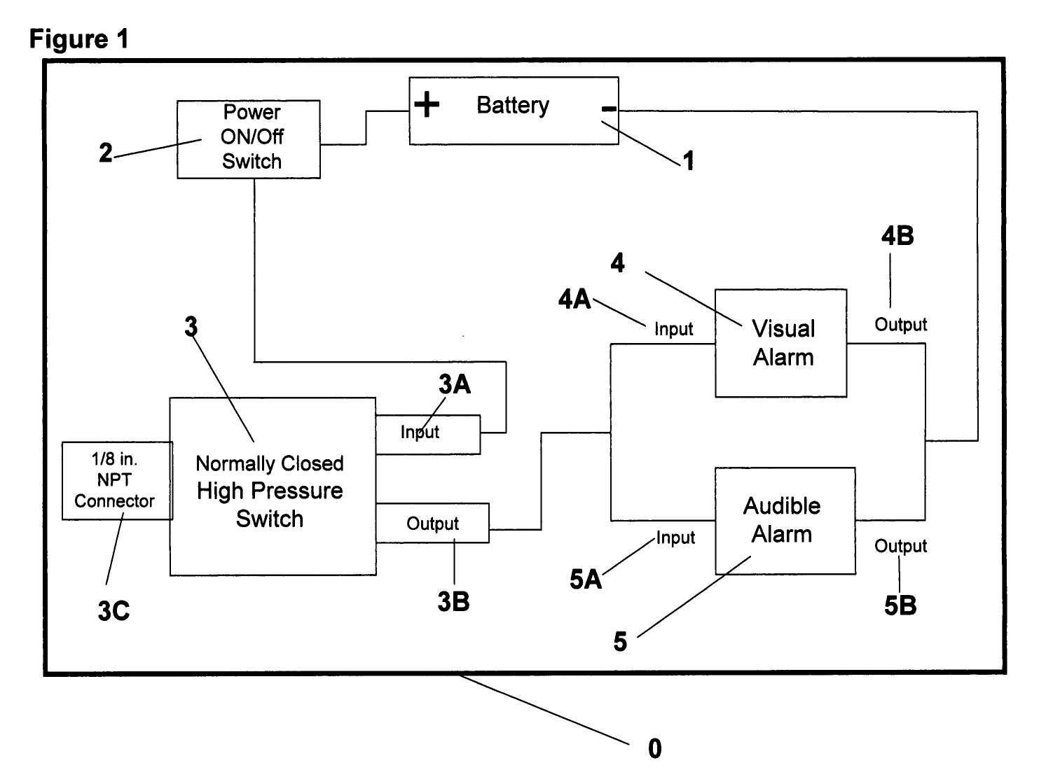

Referring now to FIG. 1: the device 0 is comprised of: a 1.5 volt to about 12 volt battery 1, preferably 9 volt, having positive (+) terminal and a negative (−) terminal; power on/off switch 2; normally closed high pressure switch 3, having input terminal 3A, output terminal 3B and internal electrical contacts; visual alarm 4 of the LED type, preferably red, having input 4A and output 4B, audible alarm 5 of the magnetic buzzer or piezo type, preferably magnetic buzzer type, capable of producing an audible sound of about 80 db to about 95 db, having input 5A and output 5B

With regard to safe operation of the device at high pressure, about 2,800 psi for a full oxygen tank; normally closed high pressure switch 3 is specified to be “oxygen clean” and having an operating pressure of at least 3000 psi, proof pressure of about 3500 psi and burst pressure of about 5000 psi where the internal electrical contacts close when pressure drops to a predetermined limit. Such a switch can be purchased from MAMCO Precision Switches, 147 River Street, Oneonta, N.Y. 13820.

To effect the operation of device 0: input terminal 3A of high pressure switch 3 is electrically connected through power on/off switch 2 to the positive terminal of battery 1; output terminal 3B of normally closed high pressure switch 3 is connected to input 4A of visual alarm 4 and to input 5A of audible alarm 5; output 4B of visual alarm 4 and output 5B of audible alarm 5 are connected to the negative terminal of battery 1.

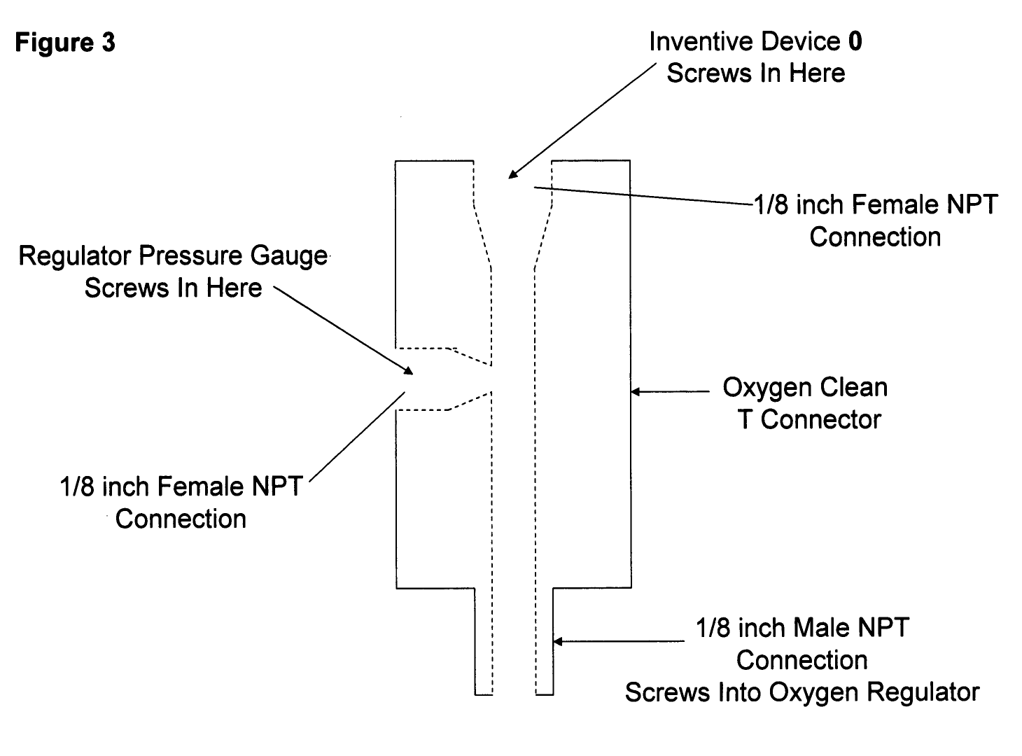

Finally device 0 is affixed to an oxygen regulator such as Probasics Model #88-8EMMR by screwing male ⅛ inch NPT connector 3C of high pressure switch 3 into an “oxygen clean” T connector having two female ⅛ inch NPT connectors and one male ⅛ inch NPT connector as shown in FIG. 3. Connector 3C is screwed into one of the female ⅛ inch connectors of the T; preferably the female connector perpendicular to the male ⅛ inch NPT connector of the T. Next the oxygen gauge is removed from the oxygen regulator and screwed into the remaining female ⅛ inch NPT connector of the T. The T, now having the oxygen pressure gauge of the oxygen regulator and device 0 attached, is affixed to the regulator by screwing the male ⅛ inch NPT connector of the T into the regulator's female ⅛ NPT available as a result of removing the oxygen pressure gauge. The oxygen regulator; now equipped with a gauge and device 0 is then attached to a medical oxygen tank or cylinder using standard practices.

When power on/off switch 2 is in the “on” position; visual alarm 4 and audible alarm 5 are activated; producing continuously, a red visual alarm and a loud buzzing alarm which is audible indoors to about 50 feet.

When the regulator is turned on; the electrical contacts within normally closed high pressure switch 3 open as a result of the pressure of the oxygen tank exceeding a preset limit, preferably about 500 psi and visual alarm 4 and audible alarm 5 are deactivated.

When the oxygen tank's pressure, as a result of oxygen usage by the patient, drops to a preset limit, preferably 500 psi; the electrical contacts within normally closed high pressure switch 3 close and visual alarm 4 and audible alarm 5 are activated to give continuous alarm until the oxygen tank is replaced by a caregiver.

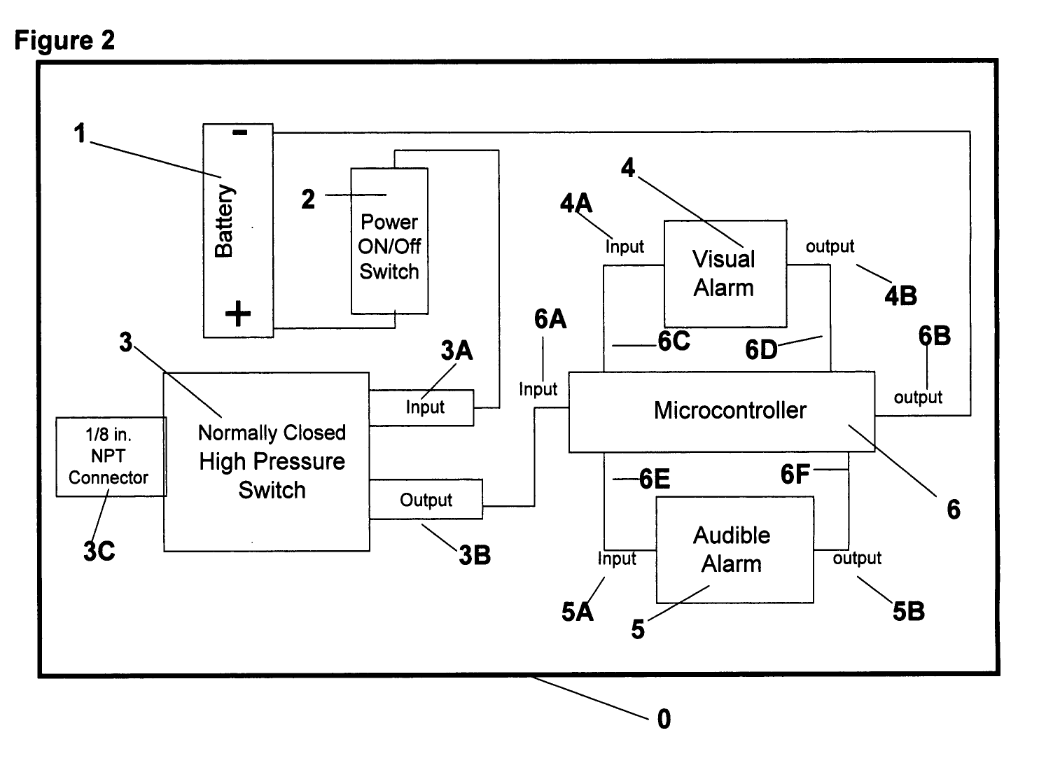

Referring now to FIG. 2, depicting a second embodiment: the device 0 is comprised of: a 1.5 volt to about 12 volt battery 1, preferably 9 volt, having positive (+) terminal and a negative (−) terminal; power on/off switch 2; normally closed high pressure switch 3, having input terminal 3A, output terminal 3B and internal electrical contacts; visual alarm 4 of the LED type, preferably red, having input 4A and output 4B, audible alarm 5 of the magnetic buzzer or piezo type, preferably piezo type, capable of producing an audible sound of about 80 db to about 95 db, having input 5A and output 5B and microcontroller 6 having input 6A, output 6B, and pin outs 6C, 6D, 6E, 6F.

With regard to safe operation of the device at high pressure; normally closed high pressure switch 3 is specified to be “oxygen clean” and having an operating pressure of at least 3000 psi, proof pressure of about 3500 psi and burst pressure of about 5000 psi where the internal electrical contacts close when pressure drops to a predetermined limit. Such a switch can be purchased from MAMCO Precision Switches, 147 River Street, Oneonta, N.Y. 13820.

With regard to microcontroller 6, a subroutine built in at manufacture, causes audible alarm 5 to “chirp.” Each chirp consists of a fixed on-time and a fixed off-time. These on- and off-times are determined experimentally, and are subjectively chosen to make the audible alarm as noticeable as possible. In like manner a built in subroutine causes visual alarm 4 to flash at a predetermined rate, such as once a second to make the visual alarm as noticeable as possible. Such microcontrollers are available in the marketplace; one manufacturer being Maxim Integrated Products, Inc. 120 San Gabriel Drive Sunnyvale, Calif. 94086 USA

To effect the operation of device 0: input terminal 3A of high pressure switch 3 is electrically connected through power on/off switch 2 to the positive terminal of battery 1; output terminal 3B of normally closed high pressure switch 3 is electrically connected to input 6A of microcontroller 6; pin out 6C of microcontroller 6 is electrically connected to input 4A of visual alarm 4; pin out 6D of microcontroller 6 is electrically connected to output 4B of visual alarm 4; pin out 6E of microcontroller 6 is electrically connected to input 5A of audible alarm 5; pin out 6F of microcontroller 6 is electrically connected to output 5B of audible alarm 5 and output 6B of microcontroller 6 is electrically connected to the negative terminal of battery 1.

Finally device 0 is affixed to an oxygen regulator such as Probasics Model #88-8EMMR by screwing male ⅛ inch NPT connector 3C of high pressure switch 3 into an “oxygen clean” T connector having two female ⅛ inch NPT connectors and one male ⅛ inch NPT connector as shown in FIG. 3. Connector 3C is screwed into one of the female ⅛ inch connectors of the T; preferably the female connector perpendicular to the male ⅛ inch NPT connector of the T. Next the oxygen gauge is removed from the oxygen regulator and screwed into the remaining female ⅛ inch NPT connector of the T. The T, now having the oxygen pressure gauge of the oxygen regulator and device 0 attached, is affixed to the regulator by screwing the male ⅛ inch NPT connector of the T into the regulator's female ⅛ NPT available as a result of removing the oxygen pressure gauge. The oxygen regulator; now equipped with its pressure gauge and device 0, is then attached, using standard practices, to a medical oxygen tank or cylinder.

When power on/off switch 2 is in the “on” position; microcontroller 6 is activated through normally closed high pressure switch 3 and causes visual alarm 4 and audible alarm 5 to be activated in an intermittent manner directed by the microcontroller 6 subroutine.

When the regulator is turned on; the electrical contacts within normally closed high pressure switch 3 open as a result of the pressure of the oxygen tank exceeding a preset limit, preferably about 500 psi and microcontroller 6 is deactivated causing visual alarm 4 and audible alarm 5 to be deactivated.

When the oxygen tank's pressure, as a result of oxygen usage by the patient, drops to a preset limit, preferably 500 psi; the electrical contacts within normally closed high pressure switch 3 close and microcontroller 6 is activated and causes visual alarm 4 and audible alarm 5 to be activated in an intermittent manner directed by the microcontroller 6 subroutine until the oxygen tank is replaced by a caregiver.

The method and embodiments of the current invention have been-described in connection with providing a visual alarm and an auditory alarm for empty oxygen bottles such as used by medical patients thereby the risk of a life threatening peril. All such modifications and alterations should be apparent to those skilled in the art as well as all such configurations and embodiments of the method and are deemed to be encompassed within the spirit and scope of the claims as set forth below.

What is claimed is:

1. A method for determining empty and/or near empty medical oxygen tanks, comprising the steps of:
a. employing a means to issue a visual and audible alarm when the oxygen pressure of a medical or other medical emergency oxygen tank has decreased to a predetermined pressure, conventionally 500 psi, and;
b. whereby said means continually issues visual and audible alarms until the oxygen tank is replaced.

2. A single, simple, 5 component device for practicing the method of claim 1 comprising:
a. a battery power source of 1.5 volts to about 12 volts, preferably 9 volts;
b. a power on/off switch;
c. a normally closed “oxygen clean” high pressure switch having a maximum operating pressure of at least 3000 psi, proof pressure of about 3500 psi, burst pressure of about 5000 psi and having an electrical input/output means and an internal switching means to make or break electrical contact and a ⅛ inch NPT to a ¼ inch NPT connector, preferably a ⅛ inch male NPT connector, to effect communication of the device to the pressurized oxygen contained in the oxygen tank;
d. a visual alarm of the LED type, preferably a red LED;
e. an audible alarm of the magnetic buzzer or piezo type, preferably the magnetic type, capable of producing an audible sound of about 80 db to about 95 db.

3. An second embodiment the method of claim 1 comprising the steps of:
a. employing a means to issue a visual and audible alarm when the oxygen pressure of a medical oxygen tank has decreased to a predetermined pressure, conventionally 500 psi, and;
b. whereby said means intermittently issues visual and audible alarms controlled by a built in subroutine of a microcontroller until the oxygen tank is replaced.

4. A single, simple, 6 component device for practicing the method of claim 3 comprising:
a. a battery power source of 1.5 volts to about 12 volts, preferably 9 volts;
b. a power on/off switch;
c. a normally closed “oxygen clean” high pressure switch having a maximum operating pressure of at least 3000 psi, proof pressure of about 3500 psi, burst pressure of about 5000 psi and having an electrical input/output means and an internal switching means to make or break electrical contact and a ⅛ inch NPT to a ¼ inch NPT connector, preferably a ⅛ inch male NPT connector, to effect communication of the device to the pressurized oxygen contained in the oxygen tank;
d. a visual alarm of the LED type, preferably a red LED;
e. an audible alarm of the magnetic buzzer or piezo type, preferably piezo type, capable of producing an audible sound of about 80 db to about 95 db;
f. a microcontroller having subroutines built in at manufacture to communicate with and produce intermittent alarming of the visual and audible alarms.
